(19) United States
(12) Patent Application Publication
(10) Pub. No.: US 2013/0062423 A1
(43) Pub. Date: Mar. 14, 2013

(54) POLYURETHANE ELASTOMER BALLAST MAT AND PREPARATION THEREOF

(71) Applicants: Chenxi Zhang, Pudong (CN); Yongdong Pang, Pudong (CN); Jen Chieh Roy Lin, Pudong (CN); Xiang Tan, Pudong (CN)

(72) Inventors: Chenxi Zhang, Pudong (CN); Yongdong Pang, Pudong (CN); Jen Chieh Roy Lin, Pudong (CN); Xiang Tan, Pudong (CN)

(73) Assignee: Bayer Intellectual Property GmbH, Monheim (DE)

(21) Appl. No.: 13/583,515

(22) PCT Filed: Mar. 4, 2011
(86) PCT No.: PCT/EP2011/053290

§ 371 Date: Nov. 26, 2012

(30) Foreign Application Priority Data
Mar. 9, 2010 (CN) CN201010120634.2

(51) Int. Cl. E01B 1/00; B05D 1/02

(52) U.S. Cl. 238/2; 427/427.4

(57) ABSTRACT

The present invention provides a polyurethane elastomer ballast mat and the preparation thereof, and a railway track bed and railway facilities using the same. The polyurethane elastomer ballast mat according to this invention comprises a reaction product prepared by spraying a reaction system comprising a polyisocyanate, a polyol, a chain extender, a blowing agent and a catalyst, on the surface of a railway roadbed or on one surface of a ballast mat shielding to conduct a reaction. The technical solution of the present invention makes it possible to provide ballast mats with different mechanical properties, shapes, thicknesses and sizes, depending on particular installation conditions, in order to adapt to various requirements for installation and use in railway construction.

### TECHNICAL FIELD

The invention relates to the field of polyurethanes, and in particular, to a polyurethane elastomer ballast mat, the preparation thereof, and a railway track bed and a railway using the same.

### BACKGROUND ART

A railway track bed generally refers to a ballast layer laid on a roadbed and under the sleepers. It forms the foundation of a rail framework. It serves mainly to support the rail sleepers and disperse the load of a bulky railway vehicle transmitted through rails and rail sleepers uniformly on the surface of a roadbed, so as to reduce the deformation of a roadbed, and to ensure train operation safety. Ballast also has the actions of shock absorption and vibration attenuation. A ballasted track bed has especially good versatility and low construction cost, and thus has been used extensively.

A ballasted track bed needs expensive maintenance: in addition to regular maintenance, it must be repaired periodically by utilizing an outage skylight, or by a large maintenance machinery when train transportation is interrupted. This is because the ballast particulates may change their positions in the structure of the track bed during their use owing to the vibration transmitted from the rail sleepers, and the sharp edge of ballast is worn gradually to become blunt, thereby causing pulverization. In addition, the ballast, in terms of its particulate structure, cannot stop external contaminants, such as coals, dusts, sands or garbages, from entering into a track bed, thereby hardening phenomena being observed in the track bed. An even more serious problem is, among others, the subsidence of track bed, pulp and mud tumbling, or the rupture of the sleepers or rails, which causes enormous dangers. If a ballasted railway passes through an urban area, the disturbing vibration and noise from a railway vehicle are also condemned by the residents.

Some technical solutions have been developed in the prior art to solve the problems associated with transportation reliability and maintenance cost caused by the vibration of a ballasted track bed railway, such as by using a ballast mat, etc. A ballast mat is composed of, for example, rubber, naturally occurring porous cork, polyurethane composite rubber fiber, rubber particulates, or polyurethane microporous elastomer, among which a polyurethane elastomer ballast mat is particularly recommended owing to its outstanding durability and vibration absorbability. Examples which may be mentioned are those commercially available from Getzner under Sylomer® and Sylodyn®, which are produced by mold pressing, adhering or mix milling, followed by cutting to form a sheet for selling and use.

However, current polyurethane elastomer ballast mats may be not suitable for complicated surrounding conditions where a ballasted track bed is laid. A ready-made ballast mat only meets a single requirement for installation and use, but is not adapted to particular conditions where different properties, thicknesses and shapes of the ballast mat are required. A ballast mat produced by cutting also has deteriorated use performance and lifetime owing to the presence of cutting sections.

### CONTENT OF THE INVENTION

An object of the invention is to provide a process for preparing a polyurethane elastomer ballast mat, which, according to an example of the present invention, comprises the steps of: spraying a reaction system comprising, as components:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an araliphatic (aromatic-aliphatic) hydrocarbon group having 8 to 15 carbon atoms, and n is 2 to 4;
b) a polyol or a mixture of polyols, said polyol having an average molecular weight of 100 to 10,000 and a functionality of 1 to 5;
c) one or more chain extenders, said chain extender comprising a reactive hydrogen atom-containing compound with a molecular weight less than 800;
d) one or more blowing agents; and
e) 0.001-10% of one or more catalysts, based on the total weight of the polyols in the reaction system,
   on the surface of a railway roadbed or on one surface of a ballast mat shielding to conduct a reaction to obtain the polyurethane elastomer ballast mat.

Another object of the invention is to provide a polyurethane elastomer ballast mat, which, according to an example of the present invention, comprises a reaction product prepared by spraying a reaction system comprising, as components:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4;
b) a polyol or a mixture of polyols, said polyol having an average molecular weight of 100 to 10,000 and a functionality of 1 to 5;
c) one or more chain extenders, said chain extender comprising a reactive hydrogen atom-containing compound with a molecular weight less than 800;
d) one or more blowing agents; and
e) 0.001-10% of one or more catalysts, based on the total weight of the polyols in the reaction system,
   on the surface of a railway roadbed or on one surface of a ballast mat shielding to conduct a reaction.

Yet another object of the invention is to provide a railway track bed, which, according to an example of the present invention, comprises:

a ballast layer,

a ballast mat shielding,

a ballast mat, and

a railway roadbed;

the ballast mat being arranged on the top of the railway roadbed, and the ballast mat shielding being arranged between the ballast layer and the layer of the ballast mat;

wherein the ballast mat comprises a reaction product prepared by spraying a reaction system comprising, as components:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4;
b) a polyol or a mixture of polyols, said polyol having an average molecular weight of 100 to 10,000 and a functionality of 1 to 5;
c) one or more chain extenders, said chain extender comprising a reactive hydrogen atom-containing compound with a molecular weight less than 800;
d) one or more blowing agents; and
e) 0.001-10% of one or more catalysts, based on the total weight of the polyols in the reaction system,
   on the surface of the railway roadbed or on one surface of the ballast mat shielding to conduct a reaction.

Still another object of the invention is to provide railway facilities, which, according to an example of the invention, comprise:

a rail,

a plurality of rail sleepers,

a ballast layer,

a ballast shielding [sic],

a ballast mat, and

a railway roadbed;

the ballast mat being arranged on the top of the railway roadbed, the ballast mat shielding being arranged between the ballast layer and the layer of the ballast mat, the rail sleepers being laid on the ballast layer, and the rail being laid on the rail sleepers to bear the load from a railway vehicle;

wherein the ballast mat comprises a reaction product prepared by spraying a reaction system comprising, as components:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4;
b) a polyol or a mixture of polyols, said polyol having an average molecular weight of 100 to 10,000 and a functionality of 1 to 5;
c) one or more chain extenders, said chain extender comprising a reactive hydrogen atom-containing compound with a molecular weight less than 800;
d) one or more blowing agents; and
e) 0.001-10% of one or more catalysts, based on the total weight of the polyols in the reaction system,
   on the surface of the railway roadbed or on one surface of the ballast mat shielding to conduct a reaction.

Preferably, the polyol is one or more selected from the group consisting of polyether polyol, polyester polyol, polycarbonate polyol, and any mixture thereof.

Preferably, the chain extender comprises a reactive hydrogen atom-containing compound with a molecular weight in the range of 18 to 400.

Preferably, the blowing agent is one or more selected from the group consisting of water, a halogenated hydrocarbon, a hydrocarbon, and a gas.

Preferably, the ballast mat shielding comprises polypropylene non-woven fabrics (geo-textile) and/or glass fiber and/or other reinforced webbed fabrics. It can be either a surface layer, or the one enclosing the prepared polyurethane elastomer ballast mat wholly.

Still another object of the invention is use of the polyurethane elastomer ballast mat according to the invention in the construction and/or maintenance of a railway track bed and railway facilities.

In the present invention, the microporous polyurethane elastomer ballast mat is formed by spraying on the surface of a railway roadbed or on one surface of a ballast mat shielding. This technique makes it possible to adjust a ballast mat in terms of mechanical properties, density, thickness and shapes according to on-site conditions. The resulting ballast mat has better adaptability to a variety of complicated installation surroundings and conditions than the current ready-made ballast mats in batches, thereby resulting in higher efficiency. Moreover, the thus-obtained ballast mat is in a closed cell structure, and is free of sections easily caused by outside erosion since no cutting processing is needed. This leads to less destruction of the polyurethane elastomer structure, and therefore ensures the performance stability of the ballast mat during a long period. As a result, the ballasted track bed attenuates vibration and noise and prevents subsidence in a better way such that both the construction and maintenance costs are lowered.

### BRIEF DESCRIPTION OF THE DRAWINGS

FIG. 1 is a schematic diagram illustrating the preparation of a polyurethane elastomer ballast mat by spraying according to an example of the present invention.

FIG. 2 is a schematic diagram illustrating the use, on a railway roadbed, of the polyurethane elastomer ballast mat prepared by spraying according to an example of the present invention.

The same signs used in the drawings represent the same or similar structures or functions. These drawings are illustrative for the present invention and is by no means limiting.

### MODE FOR CARRYING OUT THE INVENTION

The present invention provides a polyurethane elastomer ballast mat and the preparation thereof. By spraying according to the invention, it is possible to prepare a polyurethane elastomer ballast mat with appropriate mechanical properties, product density, thickness and shape depending on particular and complicated installation surroundings and conditions. The problems associated with the limited range of applications of a ready-made product and the destructed structure of polyurethane elastomer ballast mat thereof owing to cutting can thus avoided. As a result, the performance of a ballast mat remains at a constant level.

The polyurethane elastomer ballast mat can be formed by, before reaction, spraying a polyurethane-forming reaction system on the surface of a railway roadbed. This includes direct spraying of the reaction system onto the surface of a railway roadbed, so that the resulting ballast mat is adhered to the roadbed, or onto a support (such as a fabric or a grid) laid on the surface of a roadbed, in which the support can be either the one which has been pre-laid on the surface of the railway roadbed, or the one which is displaced onto the roadbed after having been coated with the ballast mat prepared by spray coating. Advantageously, in the case where the railway roadbed is uneven owing to the underneath pipelines or other facilities, the technical solution according to the present invention makes it easy to produce a ballast mat with even surface. Moreover, the elasticity of a portion of the ballast mat under which the pipelines pass through can be differentiated from other portions, such as on a better level.

Alternatively, the polyurethane elastomer ballast mat can be formed by spraying on one surface of the ballast mat shielding (in opposition to the surface in contact with the ballast), so that the resulting ballast mat is adhered to the shielding. During the process of spraying, the shielding can be turned up to make the above surface upward, and, at the end of coating, turned over to cover the surface of a railway roadbed after the polyurethane elastomer ballast mat being formed, so that the formed ballast mat is positioned between the roadbed and the ballast mat.

The ballast mat shielding, which is used to protect the ballast mat, is typically composed of polypropylene non-woven fabrics (geo-textile) and/or glass fiber and/or other reinforced webbed fabrics, which exhibit excellent resistance to tearing and piercing. On the one hand, this shielding serves the function of stress dispersion, that is, when the ballast is pressed towards the polyurethane elastomeric ballast mat via the shielding, dispersing the load uniformly and transmitting it to the mat. On the other hand, it protects the polyurethane elastomer ballast mat from being pierced or scratched by the sharp-edged ballast.

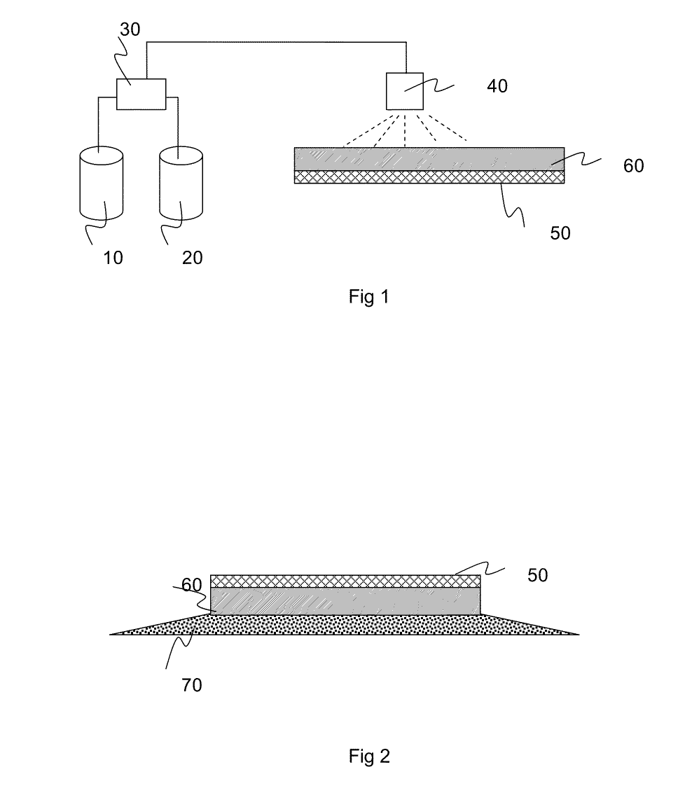

FIG. 1 is a schematic diagram illustrating the preparation of a ballast mat by spraying on the ballast mat shielding according to an example of the present invention. The polyurethane elastomer-forming reaction components are stored in a container 10 and a container 20, respectively. By means of a spraying means 30, the components are sprayed from a spraying nozzle 40 to the surface of a shielding 50, to form a polyurethane elastomer ballast mat 60. The mechanical properties of the prepared ballast mat can be varied by adjusting the volume or weight ratio between the reaction components from the container 10 and from the container 20. If necessary, the position of the spraying nozzle 40 can be changed in order to obtain a polyurethane elastomer having the same or different thickness on different sites of the shielding 50.

FIG. 2 is a schematic diagram illustrating the use, on a railway roadbed, of the ballast mat prepared by spraying according to an example of the present invention. As shown in the figure, a ballast mat 60 prepared according to the invention, upon which a shielding 50 is laid, is arranged on a railway roadbed 70. In this example, the ballast mat 60 can be formed by directly spraying, according to the example illustrated by FIG. 1, on one surface of the shielding 50, which is in turn turned over to cover the railway roadbed 70. Alternatively, the ballast mat 60 is prepared by directly spraying the components of the polyurethane elastomer-forming reaction system, using the spray means 30, on the roadbed 70, and then laid on with the shielding 50. In this case, the shielding 50 can be laid before the complete curing of the polyurethane elastomer, so that it can be adhered to directly thanks to the cohesion of the polyurethane elastomer-forming reaction system. The other surface of the shielding 50 (in contact with the ballast) will be used for ballast laying.

If it is intended to form the polyurethane elastomer ballast mat within a relatively limited or crowded region, the ballast mat in this region can also be prepared by casting the respective components of the reaction system into this region. Here, the casting should also be understood as a kind of spraying.

In addition, the present invention provides use of the polyurethane elastomer ballast mat according to the present invention in the construction and maintenance of a railway, and a railway track bed and a railway using the same.

The railway track bed according to the present invention comprises a ballast layer, a ballast mat shielding, a ballast mat and a railway roadbed; the ballast mat is arranged on the top of the roadbed, and the ballast mat shielding is arranged between the ballast layer and the layer of the ballast mat, wherein the ballast mat is the one prepared according to the invention. The railway facilities according to the present invention comprises a rail, a plurality of rail sleepers, a ballast layer, a ballast shielding, a ballast mat, and a railway roadbed; the ballast mat is arranged on the top of the railway roadbed, the ballast mat shielding is arranged between the ballast layer and the layer of the ballast mat, the rail sleepers is laid on the ballast layer, and the rail is laid on the rail sleepers to bear the load from a railway vehicle, wherein the ballast mat is the one prepared according to the invention.

The polyurethane elastomer ballast mat, the railway track bed and the railway facilities according to the invention are effective in reducing the vibration and noise caused by a railway load and other problems.

The spraying means useful in the present invention can be those sold in the market for spraying polyurethane, and the spray gun can be any conventional ones.

The reaction system of the present invention comprises a polyisocyanate or a mixture of polyisocyanates; a polyol or a mixture of polyols; one or more chain extenders; one or more blowing agents; and 0.001-10% of one or more catalysts, based on the total weight of the polyols in the reaction system. The polyurethane elastomer prepared from this system is microporous and exhibits excellent vibration absorbability.

The polyisocyanate comprises one polyisocyanate or a mixture of a plurality of polyisocyanates. The polyisocyanate is represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4.

The polyisocyanate preferably includes, but is not limited to, ethylidene diisocyanate, tetramethylene-1,4-diisocyanate, hexamethylene diisocyanate (HDI), dodecamethylene-1,2-diisocyanate, cyclobutane-1,3-diisocyanate, cyclohexane-1,3-diisocyante, cyclohexane-1,4-diisocyante, 1-isocyanato-3,3,5 -trimethyl-5-isocyanatomethyl-cyclohexane, hexahydrotoluene-2,4-diisocyanate, hexahydrotoluene-2,6-diisocyanate, hexahydrophenyl-1,3-diisocyanate, hexahydrophenyl-1,4-diisocyante, perhydro-diphenylmethane-2,4-diisocyante, perhydro-diphenylmethane-4,4-diisocyanate, phenylene-1,3-diisocyanate, phenylene-1,4-diisocyanate, durene-1,4-diisocyanate, stilbene-1,4-diisocyanate, 3,3-dimethyl-4,4-diphenyldiisocyanate, tolylene-2,4-diisocyante (TDI), tolylene-2,6-diisocyanate (TDI), methylene diphenyl-2,4′-diisocyanate (MDI), methylene diphenyl-2,2′-diisocyanate (MDI), methylene diphenyl-4,4′-diisocyanate (MDI), naphthylene-1,5-diisocyanate (NDI), their isomers, and the mixtures thereof.

The polyisocyanate can also be those modified with carbodiimide, allophanate, or isocyanate. It preferably includes, but is not limited to, diphenylmethane diisocyanate, diphenylmethane diisocyanate modified with carbodiimide, their isomers, and the mixtures thereof.

The polyisocyanate can in addition be a prepolymer end-capped with an isocyanate.

The polyol can be one polyol or a mixture of a plurality of polyols. It has an average molecular weight of 100 to 10,000, preferably 150 to 2,000; and a functionality of 1 to 5, preferably 2 to 3.

The polyol preferably includes, but is not limited to, polyether polyol, polyester polyol, polycarbonate polyol, and the mixture thereof.

The polyol comprises both a small molecular polyol and polyether polyol, wherein the former preferably comprises, but is not limited to, polyhydric compounds, such as water, ethylene glycol, 1,2-propylene glycol, 1,3-propylene glycol, diethylene glycol, trimethylolpropane, and the mixture thereof.

The polyether polyol can be prepared in a manner known per se by reacting, for example, an alkylene oxide and a polyhydric alcohol, as a starter, in the presence of a catalyst. The catalyst preferably includes, but is not limited to, an alkaline hydroxide, an alkaline alkoxide, antimony pentachlorate, an etherate of boron fluoride, a double-metal cyanide, and the mixture thereof. The alkylene oxide preferably includes, but not limited to, tetrahydrofuran, ethylene oxide, 1,2-propylene oxide, 1,2-butylene oxide, 2,3-butylene oxide, styrene oxide, or the mixture thereof. The starter of polyether polyol preferably includes, but not limited to, a polyhydric compound, such as water, ethylene glycol, 1,2-propylene oxide, 1,3-propylene glycol, diethylene glycol, trimethylolpropane, and the mixture thereof.

The polyester polyol is prepared by reacting dicarboxylic acid or dicarboxylic anhydride with polyol. The dicarboxylic acid preferably includes, but is not limited to, an aliphatic carboxylic acid having 2 to 12 carbon atoms, such as succinic acid, malonic acid, glutaric acid, adipic acid, suberic acid, azelaic acid, sebacic acid, dodecanoic acid, maleic acid, fumaric acid, o-phthalic acid, isophthalic acid, p-phthalic acid, and the mixture thereof The dicarboxylic anhydride preferably includes, but is not limited to, o-phthalic anhydride, tetrachlorophthalic anhydride, maleic anhydride, and the mixture thereof. The polyol preferably includes, but is not limited to, ethylene glycol, diethylene glycol, 1,2-propylene glycol, 1,3-propylene glycol, dipropylene glycol, methyl 1,3-propylene glycol, tetramethylene glycol, pentamethylene glycol, hexamethylene glycol, neopentyl glycol, 1,10-decanediol, glycerin, trimethylolpropane, and the mixture thereof. The polyester polyol also includes those prepared from lactone, preferably such as -caprolactone, without limitation.

The polycarbonate polyol preferably includes, but is not limited to, polycarbonate diol, which is prepared by reacting diol with dialkyl or diaryl carbonate or phosgene. The diol preferably includes, but not limited to, 1,2-propylene glycol, 1,3-propylene glycol, tetramethylene glycol, pentamethylene glycol, hexamethylene glycol, diethylene glycol, trioxymethylene diol, and the mixture thereof. The dialkyl or diaryl carbonate preferably includes, but not limited to, diphenyl carbonate.

Suitable compounds to be used as chain extender typically are reactive hydrogen atom-containing compounds having a molecular weight less than 800, preferably in the range of 18 to 400. They preferably includes, but are not limited to, alkyl diol, dihydrocarbonylene diol, polyalkyl polyol, and the mixture thereof, such as ethylene glycol, tetramethylene glycol, hexamethylene glycol, heptamethylene glycol, octamethylene glycol, nonamethylene glycol, 1,10-decanediol, diethylene glycol, dipropylene glycol, polyoxyalkylene glycol, and the mixture thereof. The reactive hydrogen atom-containing compounds can also include other grafted or unsaturated alkyl diols, and the mixture thereof, such as 1,2-prypylene glycol, 2-methyl-1,3-propylene, 2,2-dimethyl-1,3-propylene glycol, 2-butyl-2-ethyl-1,3-propylene glycol, 2-butene-1,4-diol, 2-butyne-1,4-diol, alkanolamine, N-alkyl dialkanolamine, such as ethanolamine, 2-propanolamine, 3-amino-2,2-dimethylpropanol, N-methyl diethanolamine, N-ethyl diethanolamine, and the mixture thereof. They can in addition comprise aliphatic amine, aromatic amine, and the mixture thereof, such as ethylenediamine, trimethylene diamine, tetramethylene diamine, hexamethylene glycol, isophorone diamine, 1,4-cyclohexanediamine, N,N′-diethyl-phenyldiamine, 2,4-diaminotoluene, 2,6-diaminotoluene, and the mixture thereof.

The polyurethane-forming reaction system also comprises a blowing agent and a catalyst.

Suitable compounds to be used as blowing agent generally include water, a halogenated hydrocarbon, a hydrocarbon and a gas. The halogenated hydrocarbon preferably includes, but not limited to, chlorodifluoromethane, dichlorofluoromethane, dichlorofluoromethane, trichlorofluoromethane, and the mixture thereof The hydrocarbon preferably includes, but not limited to, butane, pentane, cyclopentane, hexane, cyclohexane, heptane, and the mixture thereof. The gas preferably includes, but not limited to, air, carbon dioxide, nitrogen gas, and the mixture thereof.

The catalyst preferably includes, but is not limited to, an amine catalyst, an organic metal catalyst, and the mixture thereof. The amine catalyst preferably includes, but not limited to, triethylamine, tributylamine, triethylene diamine, N-ethylmorpholine, N,N,N′,N′-tetramethyl-ethylenediamine, pentamethyl diethylene-triamine, N,N-methyl aniline, N,N-dimethyl aniline, and the mixture thereof. The organic metal catalyst preferably includes, but not limited to, an organo-tin compound, such as tin (II) acetate, tin (II) octoate, ethyl tin hexanoate, tin laurate, dibutyl tin oxide, dibutyl tin dichloride, dibutyl tin diacetate, dibutyl tin maleate, dioctyl tin diacetate, and the mixture thereof. The amount of the catalyst used is 0.001 to 10% by weight, based on the total weight of the polyol (including both the polyols as reaction component and those as chain extenders or others) in the polyurethane-forming reaction system.

### EXAMPLES

The examples and processes were described hereinbelow, which were illustrative but by no means are limiting.

### Description of Starting Materials Mentioned Hereinabove and Hereinbelow

The starting materials mentioned hereinabove and hereinbelow were described as follows:

Desmodur PF: polyether-type isocyanate prepolymer having an NCO content of 23.0%, available from the Bayer MaterialScience AG.

ARCOL 3553: polyether-type polyol, available from the Bayer MaterialScience AG.

Dabco 33LV: tertiary amine-type catalyst, available from the Air Products and Chemicals, Inc.

UL 32: organo-tin metal catalyst, available from the Momentive Performance Materials.

High pressure spraying means: Graco-Gusmer polyurethane/polyurea PU spray coater:

H-XP2/H-XP3.

### Example 1

A polyol component and an isocyanate component both at the mass temperature of 30° C. were sprayed on one surface of a shielding at the volume ratio of 100/50 by a high pressure spray coater. The polyol used was composed of 100 parts by weight of a trihydroxy alcohol, ARCOL 3553, 6 parts by weight of ethylene glycol, and 1.5 parts by weight of diethyl toluene. The isocyanate used was 56 parts by weight of Desmodur PF. Other reaction components comprised 0.6 parts by weight of 33LV and 0.02 parts by weight of UL 32, as catalysts, and 0.20 parts by weight of water as blowing agent.

The thus-prepared polyurethane ballast mat exhibited the density of 610 Kg/m³, the hardness of 53 to 55 shore A, and the static stiffness, Cstat, of 0.16 N/mm³

### Example 2

A polyol component and an isocyanate component both at the mass temperature of 30° C. were sprayed on one surface of a shielding at the volume ratio of 100/50 by a high pressure spray coater. The polyol used was composed of 100 parts by weight of a trihydroxy alcohol, ARCOL 3553, 6.71 parts by weight of ethylene glycol, and 1.5 parts by weight of diethyl toluene. The isocyanate used is 56 parts by weight of Desmodur PF. Other reaction components comprise 0.2 parts by weight of 33LV and 0.02 parts by weight of UL 32, as catalysts, and 0.10 parts by weight of water as blowing agent.

The thus-prepared polyurethane ballast mat exhibited the density of 660 Kg/m³, the hardness of 55 shore A, and the static stiffness, Cstat, of 0.17 N/mm³

### Example 3

A polyol component and an isocyanate component both at the mass temperature of 30° C. were sprayed on one surface of a shielding at the volume ratio of 100/50 by a high pressure spray coater. The polyol used was composed of 100 parts by weight of a trihydroxy alcohol, ARCOL 3553, 6.64 parts by weight of ethylene glycol, and 1.5 parts by weight of diethyl toluene. The isocyanate used was 56 parts by weight of Desmodur PF. Other reaction components comprised 0.2 parts by weight of 33LV and 0.02 parts by weight of UL 32, as catalysts, and 0.10 parts by weight of water as blowing agent.

The thus-prepared polyurethane ballast mat exhibited the density of 590 Kg/m³, the hardness of 54 shore A, and the static stiffness, Cstat, of 0.19 N/mm³

### Example 4

A polyol component and an isocyanate component both at the mass temperature of 25 to 30° C. were sprayed on one surface of a shielding at the volume ratio of 100/50 by a high pressure spray coater. The polyol used was composed of 100 parts by weight of a trihydroxy alcohol, ARCOL 3553, 6.27 parts by weight of ethylene glycol, and 1.5 parts by weight of diethyl toluene. The isocyanate used was 56 parts by weight of Desmodur PF. Other reaction components comprised 0.2 parts by weight of 33LV and 0.02 parts by weight of UL 32, as catalysts, and 0.20 parts by weight of water as blowing agent.

The thus-prepared polyurethane ballast mat exhibited the density of 480 Kg/m³, the hardness of 45 shore A, and the static stiffness, Cstat, of 0.15 N/mm³.

### Example 5

A polyol component and an isocyanate component both at the mass temperature of 25 to 30° C. were sprayed on one surface of a shielding at the volume ratio of 100/50 by a high pressure spray coater. The polyol used was composed of 100 parts by weight of a trihydroxy alcohol, ARCOL 3553, 6.0 parts by weight of ethylene glycol, and 1.5 parts by weight of diethyl toluene. The isocyanate used was 56 parts by weight of Desmodur PF. Other reaction components comprised 0.6 parts by weight of 33LV and 0.02 parts by weight of UL 32, as catalysts, and 0.20 parts by weight of water as blowing agent.

The thus-prepared polyurethane ballast mat exhibited the density of 480 Kg/m³, the hardness of 45 shore A, and the static stiffness, Cstat, of 0.14 N/mm³.

### Example 6

A polyol component and an isocyanate component both at the mass temperature of 25 to 30° C. were sprayed on one surface of a shielding at the volume ratio of 100/52 by a high pressure spray coater. The polyol used was composed of 100 parts by weight of a trihydroxy alcohol, ARCOL 3553, 6.71 parts by weight of ethylene glycol, and 1.5 parts by weight of diethyl toluene. The isocyanate used was 57 parts by weight of Desmodur PF. Other reaction components comprised 0.2 parts by weight of 33LV and 0.02 parts by weight of UL 32, as catalysts, and 0.18 parts by weight of water as blowing agent.

The thus-prepared polyurethane ballast mat exhibited the density of 500 Kg/m³, the hardness of 47 shore A, and the static stiffness, Cstat, of 0.16 N/mm³.

### Example 7

A polyol component and an isocyanate component both at the mass temperature of 25 to 30° C. were sprayed on one surface of a shielding at the volume ratio of 100/52 by a high pressure spray coater. The polyol used was composed of 100 parts by weight of a trihydroxy alcohol, ARCOL 3553, 6.0 parts by weight of ethylene glycol, 1.0 part by weight of tetramethylene glycol, and 1.5 parts by weight of diethyl toluene. The isocyanate used was 57 parts by weight of Desmodur PF. Other reaction components comprised 0.6 parts by weight of 33LV and 0.02 parts by weight of UL 32, as catalysts, and 0.18 parts by weight of water as blowing agent.

The thus-prepared polyurethane ballast mat exhibited the density of 540 Kg/m³, the hardness of 50 shore A, and the static stiffness, Cstat, of 0.23 N/mm³.

Table 1 summarized the ratio of the reaction components of respective reaction systems in Examples 1-7 and the test results from the thus-obtained polyurethane elastomer ballast mats by spraying. It can be seen from the Examples as well as the data in the table that, by adjusting the ratio of the amount of the reaction components used, it was possible to obtain polyurethane ballast mats meeting the requirements for different mechanical properties. Therefore, in accordance with the present invention, a polyurethane elastomer ballast mat with desired properties can be prepared conveniently and efficiently, depending on the particular railway construction requirements under given conditions.

TABLE 1
Reaction components in examples and test results from thus-obtained polyurethane
elastomer ballast mats

| Components | Unit | 1 | 2 | 3 | 4 | 5 | 6 | 7 |
|---|---|---|---|---|---|---|---|---|
| ARCOL 3553 | Parts | 100 | 100 | 100 | 100 | 100 | 100 | 100 |
| Diethyl toluene | Parts | 1.50 | 1.50 | 1.50 | 1.50 | 1.50 | 1.50 | 1.50 |
| Tetramethylene | Parts | 0 | 0 | 0 | 0 | 0 | 0.50 | 1.00 |
| glycol | | | | | | | | |
| Ethylene glycol | Parts | 6.00 | 6.71 | 6.63 | 6.27 | 6.00 | 6.71 | 6.71 |
| Water | Parts | 0.20 | 0.10 | 0.10 | 0.20 | 0.20 | 0.18 | 0.18 |
| 32LV | Parts | 0.60 | 0.20 | 0.20 | 0.20 | 0.60 | 0.20 | 0.20 |
| UL32 | Parts | 0.06 | 0.02 | 0.02 | 0.02 | 0.02 | 0.02 | 0.02 |
| Total amount | Parts | 108 | 109 | 108 | 108 | 108 | 109 | 110 |
| Polyether | Parts | 100 | 100 | 100 | 100 | 100 | 100 | 100 |
| Component | | | | | | | | |
| Desmodur PF | Parts | 56 | 56 | 56 | 56 | 56 | 57 | 57 |
| Cₛₜₐₜ, N/mm³ | N/mm³ | 0.16 | 0.17 | 0.19 | 0.15 | 0.14 | 0.16 | 0.23 |
| Density, kg/m3 | kg/m³ | 610 | 660 | 590 | 480 | 510 | 500 | 540 |
| Hardness | Shore A | 53 A | 55 A | 54 A | 45 A | 42 A | 47 A | 50 A |

Although the present invention was described with reference to the better examples, they are in no way limiting to the invention. Any ordinarily skilled in the art can make modifications and variations within the spirit and scope of the invention. Thus, the protection scope of the invention should be determined in view of the appended claims.

1.-15. (canceled)

16. A process for preparing a polyurethane elastomer ballast mat, comprising spraying a reaction system on a surface of a railway roadbed or on a surface of a ballast mat shielding to conduct a reaction to obtain the polyurethane elastomer ballast mat, wherein the reaction system comprises, as components:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4;
b) a polyol or a mixture of polyols, said polyol having an average molecular weight of from 100 to 10,000 and a functionality of from 1 to 5;
c) one or more chain extenders comprising a reactive hydrogen atom-containing compound with a molecular weight of less than 800;
d) one or more blowing agents; and
e) from 0.001 to 10% of one or more catalysts, based on the total weight of the polyols in the reaction system.

17. The process according to claim 16, wherein the polyol is one or more compounds selected from the group consisting of polyether polyol, polyester polyol, polycarbonate polyol, and mixtures thereof.

18. The process according to claim 16, wherein the chain extender comprises a reactive hydrogen atom-containing compound having a molecular weight of from 18 to 400.

19. The process according to claim 16, wherein the blowing agent is one or more compounds selected from the group consisting of water, a halogenated hydrocarbon, a hydrocarbon, a gas, and mixtures thereof.

20. The process according to claim 16, wherein the ballast mat shielding comprises a layer of polypropylene non-woven fabric or a layer of reinforced webbed fabric.

21. A polyurethane elastomer ballast mat, which comprises a reaction product prepared by spraying a reaction system on a surface of a railway roadbed or on a surface of a ballast mat shielding to conduct a reaction, wherein the reaction system comprises:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4;
b) a polyol or a mixture of polyols, said polyol having an average molecular weight of from 100 to 10,000 and a functionality of from 1 to 5;
c) one or more chain extenders comprising a reactive hydrogen atom-containing compound with a molecular weight of less than 800;
d) one or more blowing agents; and
e) from 0.001 to 10% of one or more catalysts, based on the total weight of the polyols in the reaction system.

22. The ballast mat according to claim 21, wherein the polyol is one or more compounds selected from the group consisting of polyether polyol, polyester polyol, polycarbonate polyol, and mixtures thereof.

23. The ballast mat according to claim 21, wherein the chain extender comprises a reactive hydrogen atom-containing compound having a molecular weight of from 18 to 400.

24. The ballast mat according to claim 21, wherein the blowing agent is one or more compounds selected from the group consisting of water, a halogenated hydrocarbon, a hydrocarbon, a gas, and mixtures thereof.

25. The ballast mat according to claim 21, wherein the ballast mat shielding comprises a layer of polypropylene non-woven fabric or a layer of reinforced webbed fabric.

26. A railway track bed, which comprises:
a ballast layer,
a ballast mat shielding,
a ballast mat, and
a railway roadbed;
wherein the ballast mat is arranged on the top of the railway roadbed, and the ballast mat shielding is arranged between the ballast layer and the layer of the ballast mat; and
wherein the ballast mat comprises a reaction product prepared by spraying a reaction system on the surface of the railway roadbed or on a surface of the ballast mat shielding to conduct a reaction, wherein the reaction system comprises, as components:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4;
b) a polyol or a mixture of polyols, said polyol having an average molecular weight of from 100 to 10,000 and a functionality of from 1 to 5;
c) one or more chain extenders comprising a reactive hydrogen atom-containing compound with a molecular weight of less than 800;
d) one or more blowing agents; and
e) from 0.001 to 10% of one or more catalysts, based on the total weight of the polyols in the reaction system.

27. The railway track bed according to claim 26, wherein the ballast mat shielding comprises a layer of polypropylene non-woven fabric or a layer of reinforced webbed fabric.

28. A railway facility, which comprises:
a rail,
a plurality of rail sleepers,
a ballast layer,
a ballast mat shielding,
a ballast mat, and
a railway roadbed;
wherein the ballast mat is arranged on the top of the railway roadbed, the ballast mat shielding is arranged between the ballast layer and the layer of the ballast mat, the rail sleepers are laid on the ballast layer, and the rail is laid on the rail sleepers to bear the load from a railway vehicle; and
wherein the ballast mat comprises a reaction product prepared by spraying a reaction system on the surface of the railway roadbed or on a surface of the ballast mat shielding to conduct a reaction, wherein the reaction system comprises, as components:
a) a polyisocyanate or a mixture of polyisocyanates, said polyisocyanate being represented by the formula of R(NCO)n, wherein R represents an aliphatic hydrocarbon group having 2 to 18 carbon atoms, an aromatic hydrocarbon group having 6 to 15 carbon atoms, or an aroaliphatic hydrocarbon group having 8 to 15 carbon atoms, and n is 2 to 4;
b) a polyol or a mixture of polyols, said polyol having an average molecular weight of from 100 to 10,000 and a functionality of from 1 to 5;
c) one or more chain extenders comprising a reactive hydrogen atom-containing compound with a molecular weight of less than 800;
d) one or more blowing agents; and
e) from 0.001 to 10% of one or more catalysts, based on the total weight of the polyols in the reaction system.

29. The railway facility according to claim 28, wherein the ballast mat shielding comprises a layer of polypropylene non-woven fabric or a layer of reinforced webbed fabric.

30. A method for constructing or maintaining a railway track bed and railway facility comprising utilizing the polyurethane elastomer ballast mat according to claim 21.
